(19) United States
(12) Patent Application Publication
(10) Pub. No.: US 2005/0240439 A1
(43) Pub. Date: Oct. 27, 2005

(54) System and method for automatic assignment of medical codes to unformatted data

(75) Inventors: Andrew B. Covit, East Brunswick, NJ (US); Mark E. Familant, Tinton Falls, NJ (US); Stuart Covit, Marlboro, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Artificial Medical Intelligence, Inc,, South River, NJ (US)

(21) Appl. No.: 11/106,817

(22) Filed: Apr. 15, 2005

Related U.S. Application Data
(60) Provisional application No. 60/562,892, filed on Apr. 15, 2004.
(60) Provisional application No. 60/644,961, filed on Jan. 19, 2005.

(51) Int. Cl. G06F 17/60

(52) U.S. Cl. 705/2

(57) ABSTRACT

A system and method for automatic assignment of medical codes to unformatted data is, for example, a computer software module or engine. The engine automatically assigns medical codes such as ICD codes (ICD9 and ICD10 as well as other versions) to unformatted or uncoded medical documents (e.g. medical notes, discharge summaries, etc.). The system reads a document and then scans (assesses) it for diagnoses associated with the medical codes. When diagnosis is identified, the system can also examine the language context in which the diagnosis appears. Using rules derived from syntactic and semantic usage, the system decides whether to apply an identified ICD code to the document being processed or not. The output of the module, a set of medical codes and the corresponding diagnoses that conform to the widely accepted syntactic and semantic rules associated with coding, can then be stored in or applied to a number of different mediums, such as data base entries, attachments to the document itself, email to the owner of the document, electronic or paper forms, etc.

### CROSS-REFERENCE TO RELATED APPLICATIONS

This application claims the benefit of the filing dates of U.S. Provisional Patent Application No. 60/562,892, filed Apr. 15, 2004, and U.S. Provisional Patent Application No. 60/644,961, filed Jan. 19, 2005, the disclosures of which are hereby incorporated herein by reference.

### BACKGROUND OF THE INVENTION

The growing complexity and interdependence of discrete computer systems requires reliance on data. Medical data requires codification for billing, classification and diagnostic use. For example, ICD codes are used to classify medical conditions or diseases and related procedures, etc. for the purpose of reporting statistical information. Such medical codes are often determined from medical documents having phrases with medical and non-medical terminology such as dictated or written medical reports, medical notes, discharge summaries, etc. To curtail the rising cost of providing health care, many attempts have been made to use computers to facilitate the delivery of health care services.

However, when associating medical codes such as ICD codes to medical records data, the standard method has been to have human coders trained to review documents and assign codes manually. This typically involves a “bank” of reviewers of various expertise (up to actual certification) reviewing the documents. The need for productivity-enhancing electronic tools has become increasingly apparent in today's health care business environment. Efforts to contain cost-of-care and show profit have forced physicians and hospitals to become more businesslike in their day-to-day practice of medicine, providing motivation to increase efficiency and decrease overhead wherever possible. At the same time, oversight by insurance providers has increased the administrative burden of practicing medicine. Each physician-patient encounter can require the physician to generate between four and twelve forms, which take an average of two to ten minutes to complete. These forms include requisitions, charge sheets, prescriptions, labels, patient information, authorization requests, referral forms, follow-up instructions, schedules etc. which must be coded properly. Despite the need to mitigate the administrative burden, current computer tools do not enhance productivity of the basic transaction of the health care industry.

Therefore, there is a need for the automatic assignment of medical codes to textual and verbal data.

### SUMMARY OF THE INVENTION

The present invention is a system and method for automatic assignment of medical codes to unformatted data.

In one version of such an automated system for determining medical codes from unformatted (i.e., un-coded) medical document data, the system has a data structure including medical codes data associated with medical terminology data. The system includes processor searching control instructions configured to search document data input to the system to automatically identify medical terminology data of the data structure located in the document data and to automatically select one or more medical codes of the data structure that are associated with the identified medical terminology data. The system may further include processor output control instructions configured to generate output including a selected medical code associated with the medical document data, etc. Optionally, the processor search control instructions are further configured to automatically examine a context of the identified medical terminology data in the document data and the selection of a medical code of the data structure is also based on the result of the examination of the context.

Optionally, the examination of context as just described may include automatically identifying further medical terminology data in the same context as the identified medical terminology data. This identified further medical terminology data may not be directly associated with a unique medical code in the data structure. Such an examination may further include selecting a medical code based on the identified further medical terminology data and a selected medical code that is associated with identified medical terminology data from the same context.

In one form, the processor search control instructions are further configured to distinguish an associated medical code of identified medical terminology data of the document data as a result of the examination of the context. Alternatively or as well, the processor search control instructions may be configured with a restriction rule including a kinship phrase. In this case, the system may distinguish a medical code as a result of an identified kinship phrase in the context of the document data.

Similarly, the system may include processor search control instructions configured with a restriction rule including a phrase of negation, wherein the system distinguishes the medical code as a result of an identified negation phrase in the context of the document data.

In one embodiment, a system may include a method for determining medical codes from unformatted electronic medical report document data containing medical terminology of several steps. One step involves searching an electronic document by an electronic processor to automatically locate occurrences of medical terminology data in the electronic document where the medical terminology data is also associated with medical designator code data in a dictionary data structure. Another step involves automatically selecting a medical code of the medical code data from an automatically located occurrence of medical terminology from the electronic document. The method also involves a step of generating output including the automatically selected medical code associated with the medical document data. Optionally, a further step may include automatically examining a context of an occurrence of medical terminology data in the medical report document data and automatically selecting a medical code based on the examination of the context. This may involve automatically distinguishing a selection of a medical code that has an association with located medical terminology of the document data.

Additional aspects of the aforementioned methods and systems will be apparent from a review of the drawings, the abstract, the detailed description and the claims.

### BRIEF DESCRIPTION OF THE DRAWINGS

A more complete understanding of the present invention may be obtained from consideration of the following description in conjunction with the drawings in which:

FIG. 1 is a stylized overview of interconnected computer system networks that may implement a system for medical code determination;

FIG. 2 is an input/output diagram illustrating a medical designator code determination module accepting unformatted document input and generating medical designator code data as output;

FIG. 3 illustrates a processor based system with memory having control instructions for determining medical designator code data from unformatted medical records or documents containing medical related terminology;

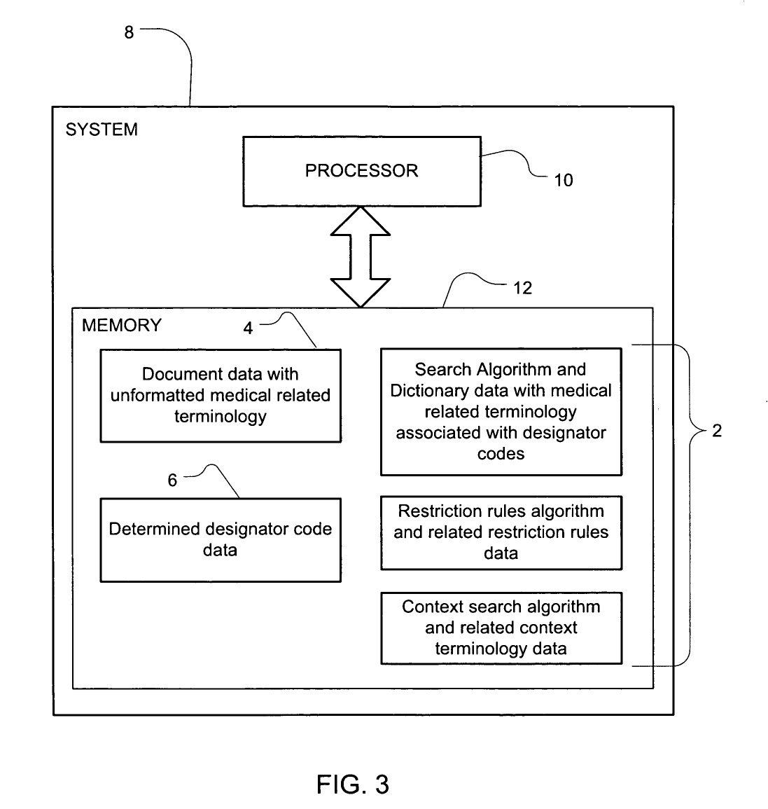

FIG. 4 is a flow chart illustrating a methodology for determining medical codes from unformatted medical terminology documents;

FIG. 5 is a data flow diagram in an example architecture for a networked system capable of implementing medical designator code determination;

FIG. 6 is a user interface log on screen for a system illustrated in FIG. 5;

FIG. 6A is a user interface for creating, changing and deleting passwords and usernames of such a code determination system;

FIG. 7 is a user interface of a system of FIG. 5 configured for permitting users to view automatically determined medical codes from medical record documents;

FIG. 7A is a user interface for examining medical documents and their associated medical codes;

FIG. 8 is the user interface of FIG. 7 permitting a user to remove a code generated with the automated medical code determination engine;

FIG. 8A is another user interface permitting a user to remove selected medical codes that are associated with one or more medical documents;

FIG. 9 is the user interface of FIG. 7 permitting a user to add additional medical codes to supplement the medical codes determined by the automated medical coding engine;

FIG. 9A is a user interface for manually searching a computerized medical code dictionary with entered text or codes for purposes of manually selecting codes to be associated with a medical document;

FIG. 10 illustrates a user interface capable of entering particular designations for certain selected medical codes assigned to medical documents;

FIG. 11 illustrates an interface for search criteria entry capable of controlling a search of documents with assigned medical codes for purposes of displaying particular documents with medical codes; and

FIG. 12 is an example interface of a supervisor station permitting a user to manage work flow in the system of FIG. 5.

### DETAILED DESCRIPTION

Although the present invention is a system and method for automatic assignment of medical codes to unformatted or uncoded document data, which is particularly well suited for implementation as an independent software systems and shall be so described, the present invention is equally well suited for implementation as a functional/library module, an applet, a plug in software application, as a device plug in, and in a microchip implementation.

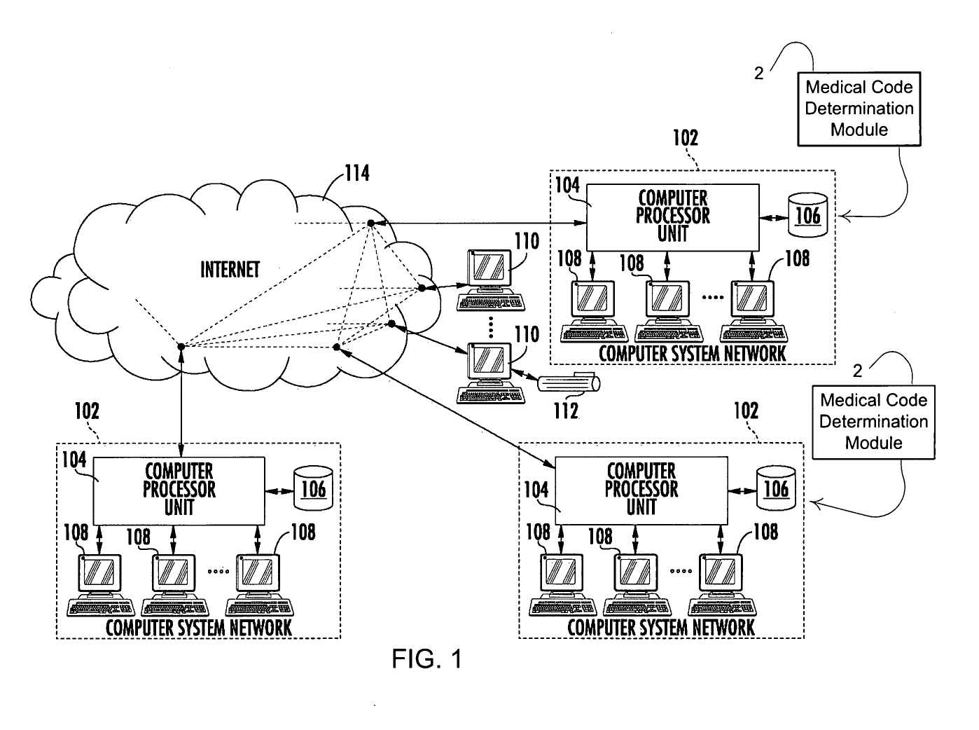

Referring to FIG. 1, there is shown a stylized overview of interconnected computer system networks. Each computer system network 102 contains a corresponding local computer processor unit 104, which are coupled to a corresponding local data storage unit 106, and local network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the Web page. The Web page may contain links to other computer systems and other Web pages. Wireless interfaces including various wireless protocols can be used to expand and increase the flexibility of the system. This can include wireless bedside computer systems, digital recording and dictation devices, OCR and hand writing recognition systems as well as other technologies known to those skilled in the art of computer networks and computer systems. Such input systems which may be directly accessible to medical practitioners or their assistants etc., can provide an input means for creating electronic medical documents that can be subsequently processed or analyzed by computer systems as discussed in more detail herein.

Where implemented as a separate software application, the system can be run on a server as a service application such as an Internet subscription service as well as traditional stand alone software application. The system can be implemented as a software module used by an application, a library routine called by an application, or a software plug in called by a browser or similar application. The system is ideally suited for implementation as a hand held digital device, such as a personal digital assistant or dedicated system, where it can act as a physical data barrier or wall, enabling the digital device to be simply plugged into existing legacy system or offered as an optional upgradeable hardware feature or a temporary device. The system can be implemented as an embedded device, such as an application specific integrated circuit (ASIC), an integrated circuit chip set, for use on a motherboard, application board, or within a larger integrated circuit. Thus, processor control instructions, whether in the form of software, firmware or hardware, may implement the functionality of a system as more fully described herein.

The boundaries of medicine are expanding at an incredible rate due to the advancements in technology enabling many innovations in reference to medical education, research, and treatment. As with all industries, the health care industry is finding numerous ways to utilize computerized networks, the internet and electronic means to instigate much-needed improvement in a variety of areas such as the collection, organization, and maintenance of information.

Descriptive health-related data can comprise an unlimited number of combinations of terms and is, therefore, inherently intractable. To handle descriptive data, each individual clinician develops his or her own preferred terminology and approach to recording the data, ranging from transcription to handwriting, to hiring staff to write or record for them. Automating such unruly data has not been efficient. Moreover, because of the wide variety of methods adopted by individual clinicians for handling such data, efforts to automate the collection of descriptive data typically disrupt the established work patterns of the clinicians.

On the other hand, functional data, such as diagnoses and care plan elements, are described by a limited set of enumerable terms, such as the diagnoses promulgated in the ICD classification and codes. Care plan items, such as ordering a specific test or carrying out certain procedures, can be described by a limited number of enumerated terms. Even prescription of medication follows codified rules and highly defined data sets. Moreover, while descriptive data is critically important to the thought processes of the clinician in assessing the patient, and is used for later review by clinicians, insurance companies, and occasionally attorneys, the functional data is more directly related to the actual practice and business of medicine. Prior art electronic systems have focused on the collection and storage of descriptive data by manual methods or methods unique to each software system.

Consider, for example, the International Classification of Diseases (ICD). The ICD is the classification used to code and classify mortality data from death certificates. The International Classification of Diseases, Clinical Modification (ICD-9-CM) is used to code and classify morbidity data from the inpatient and outpatient records, physician offices, and most National Center for Health Statistics (NCHS) surveys. The ICD-9 classification system provides principal, secondary, and tertiary diagnostic codes. The principal diagnosis is that condition established after study to be chiefly responsible for occasioning the admission of the patient to the hospital for care. The selection of principal diagnosis is determined by the circumstances of admission, diagnostic workup and/or therapy provided. The condition that best satisfies the three criteria is the principal diagnosis. The documented circumstances of admission, diagnostic workup, and treatment should support and reflect the principal diagnosis. Among the three criteria, the circumstances of inpatient admission always govern the selection of the principal diagnosis. Circumstances of admission refer to the chief complaint, as well as signs and symptoms of the patient on admission.

Other Diagnoses (ODX), also known as “secondary diagnoses,” or “additional diagnoses,” are conditions that either coexist at the time of admission or develop subsequently and affect patient care for the current hospital episode. “Affecting patient care” signifies conditions requiring any of the following: clinical evaluation, therapeutic treatment, diagnostic procedures, extended the length of hospital stay, or increased nursing care and/or monitoring. Thus, a diagnosed condition causing consumption of significant additional hospital resources is considered a valid secondary diagnosis.

The portion of the ICD-9-CM book to be used by providers consists of codes within two general ranges:
Numeric codes (001.0 to 999.9) that are broken down into 17 classifications of diseases and injuries.
V codes (V01.0 to V82.9) that describe causes of a patient visit for reasons other than disease or injury.

Requiring each clinician to electronically enter descriptive encounter data in such a singular, non-customary manner typically detracts from their clinician's efficiency.

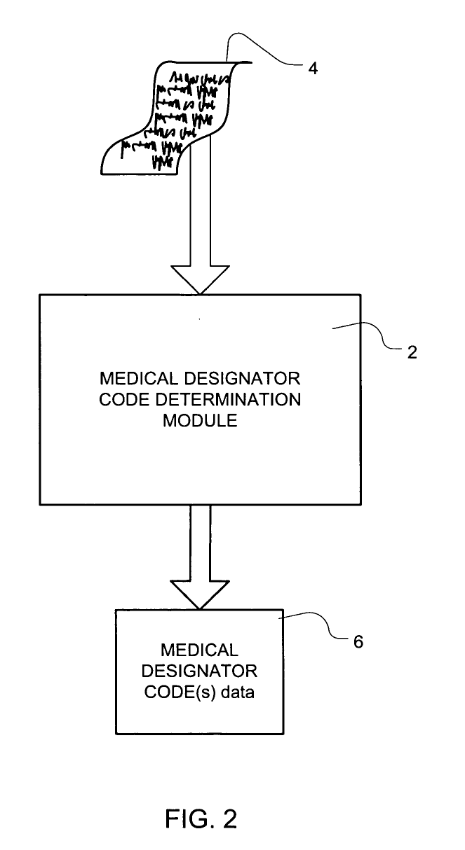

Generally, as illustrated in FIG. 2, the present system and method contemplates automatic assignment of medical codes to unformatted or uncoded data such as the unformatted data contained in medical documents or reports generated by physicians or medical practitioners during medical examination which must subsequently be converted to specific codes for subsequent processing or analysis. A particular example coding system 8 (designated by the inventors as the “ICDScan” or “EMscribe Dx”) implements computerized intelligent methods for such automated determination of ICD codes. Such a system typically includes a processor control instruction module 2 or coding engine, such as computer software, that automatically assigns or determines the medical codes (e.g., ICD codes such as ICD9 and ICD10 as well as other versions, CCI codes, CIHI codes, CPT codes, etc.) to unformatted medical documents 4 (e.g., medical notes, discharge summaries, etc.) that have been electronically input into the system. For example, the module 2 run by a processor 10 and stored in memory 12 accesses data from such documents 4 and then scans the data for diagnoses terminology associated with ICD codes. If a diagnosis is identified, the system may examine the language context in which the diagnosis appears. Using rules derived from syntactic and semantic usage, the module 2 may be configured to determine whether to apply an identified medical code (e.g., ICD code) to the document being processed or not. The output of the module 2 may include medical codes data 6 with a set of ICD codes and the corresponding diagnoses that conform to the widely accepted syntactic and semantic rules associated with such code determination. This output can then be stored in a number of different mediums, such as data base entries, attachments or insertions to the document itself, email to the owner of the document 4, etc. such that the data can be utilized more effectively having been classified with one or more ICD codes or other medical identifier codes.

Technical Methodology Details

In the particular example of determining ICD medical designator codes, there are many thousands of such ICD codes. An example of the complexity includes the heart attack codes (30—each separate for acuity, complexity, location and severity). There are another 10 that refer to syndromes related (chest pain, angina, post infarction pain, etc.). Each, however, are very specific.

To determine whether any one of them should be assigned to a document, the expression corresponding to the code needs to be found in the document. For example, assigning a code of “410” requires that the associated expression “acute myocardial infarction” appear in the text being analyzed. A simple algorithm would search a document serially for each of the expressions corresponding to the ICD codes. If a match was found, the ICD code would be assigned to the document. However, the simple algorithm does not always provide accurate code determination of all documents for two reasons.

The first reason is that the simple algorithm under-codes, that is, it will not always locate the medical diagnosis terminology in the document to identify an associated medical diagnosis designator code or ICD code even though the document actually indicates that such a diagnosis has been described. Creators of medical documents frequently do not use the exact same expressions that are present in the official ICD corpus. They employ slang or abbreviations or alternative expressions. Because of this, if the official ICD corpus was the sole source for diagnostic expressions, the module would identify codes less often than it should.

The following sentence, E1, is one in which the simple algorithm would under code.
(E1) “Mr. John Doe returns for follow-up on 2/15/03. As you know, he was referred for renovascular disease.”

The term “renovascular disease” is slang. It is not part of the ICD9 dictionary of expressions. Because of this, the simple algorithm, using the standard ICD9 dictionary would never encode renovascular disease (the official expression in the ICD9 corpus is “ATHEROSCLEROSIS OF RENAL ARTERY”). However, medical practitioners know that renovascular disease is just another term for atherosclerosis of renal artery but ICD dictionaries do not.

Second is that the simple algorithm over-codes, that is, it will identify ICD codes for terminology of a document where such an ICD code does not actually represent an actual or pertinent medical diagnosis made in the document. For example, terminology associated with ICD codes are used in different contexts in medical documents. In some of these contexts, it would be inappropriate to assign a medical designator code even if a terminology match is made. For example, if a document creator is talking about the brother of the main subject of a medical document and describes that brother as having osteoporosis, assigning the corresponding code to the document would be inappropriate. The document creator is describing the brother of the subject, not the subject and ICD codes should be applied only to the subject of the document.

In the following example, E2, the simple algorithm would over-code.
(E2) “She denies any history of abnormal urinalysis such as hematuria, proteinuria, nephrolithiasis, or other genitourinary complaints.”

In the context of this sentence, the patient is denying having any of the diagnoses listed (hematuria, proteinuria, and nephrolithiasis). However, the simple algorithm would code each of these because it performs a pattern match between the expression in the ICD dictionary (in this case the expressions would be “hematuria” and “proteinuria”) and the document being analyzed. The simple algorithm does not take into account the syntactic and semantic structure of the sentence. In this case, the word “denies” is a token which signals to someone who understands English that these diagnosis should not be applied to the subject of the sentence “She,” at least according to the patient. Because the simple algorithm does not have an understanding of English, it does not understand that it should not encode in this instance.

Methodology For Mitigating Under-Coding

An automated medical code determination system 8, such as the so-called “ICDScan” or “EMscribe Dx” system in the example of determining ICD codes, may be implemented to address the under-coding problem in two ways. Either one of the methods may be implemented but it is preferred to have a system implement both. The first methodology includes providing an expanded coding dictionary or otherwise such as by expanding the ICD Code Dictionary. To encode documents, a dictionary or other searchable data structure is needed that maps English expressions of medical related terminology to alphanumeric codes. In the example, the structure of the standard ICD code dictionary may be a simple flat file consisting of the alphanumeric ICD code in one field and a corresponding or associated expression in a second field. In the system of the improved approach, multiple expressions can map to a single code in the dictionary. This expands the dictionary, adding thousands of additional entries with medical related terminology or expressions that may be associated with the medical or ICD code. For example, a modified dictionary file can add numerous entities including slang terminology (e.g., “cardiac infarct”), lay terminology (e.g., “heart attack”), abbreviated forms of terminology (e.g., “MI”), and even misspelled terminology (e.g., “myocardial”) to be associated with heart attack codes.

By way of further example, Table 2 below is a fragment of an expanded dictionary from a section of an ICD standard dictionary illustrating augmentation with alternative expressions such as that found in example E1 above. The ICD codes essentially consist of 3-5 digit numbers (formatted: XXX.XX) to cover all medical illnesses (e.g. 584.9 acute renal failure) and conditions (e.g., V42.0 post kidney transplant).

TABLE 2

| | |
|---|---|
| 438.9 | LT EFF CEREBROVAS DIS UNSPEC |
| 440 | ATHEROSCLEROSIS OF AORTA |
| 440 | AORTIC ATHEROSCLEROSIS |
| 440 | ATHEROSCLEROSIS AORTA |
| 440.1 | renal artery, with pre- |
| | occlusive stenosis |
| 440.1 | renal artery with pre- |
| | occlusive stenosis |
| 440.1 | ATHEROSCLEROSIS OF RENAL |
| | ARTERY |
| 440.1 | ATHEROSCLEROSIS RENAL ARTERY |
| 440.1 | renal artery atherosclerosis |
| 440.1 | renal artery stenosis |
| 440.1 | renovascular disease |

The ICD9 code is in the left column and the expression on which the ICDScan system matches is in the right one. The expressions in uppercase are part of the official corpus of ICD9 expressions while the expressions in lowercase are examples that may be added to this dictionary to take into account alternative ways of expressing the diagnosis coded as ICD code “440.1.” In this Figure, it can be seen that one of the additional entries is “renovascular disease” (the last entry in the Figure), the nonstandard expression shown in example E1 above.

Thus, as can be seen from the ICD example of Table 2, the improved dictionary expands the standard code dictionary or data structure such as a table, database, etc. by adding expressions of medical related terminology that can map to certain codes. These new expressions consist of slang, abbreviations, expansions of phrases, alternative orders or spellings of phrases, etc. These new entries in the dictionary may be obtained through knowledge engineering of medical domain experts and analysis of medical documents.

Thus, an embodiment of such a system implementing automated ICD determination may include the entire corpus of the ICD dictionary supplemented by thousands of additional entries.

The second approach is to implement what may be considered a context algorithm. The context algorithm operates on a document after searching the document for medical related terminology associated with entries in the code dictionary and one or more preliminary assignments to a code has been made.

For example, in certain cases, the code associated with a vague expression present in a document can be substituted for a more specific code expression if other codes, context codes, are also determined. This may be illustrated, in example E3 below, with reference to a “transplant.”
(E3) “Subsequently he developed progressive renal failure and eventually required transplant for management of his end stage renal disease.”

The token “transplant” in and of itself may not be a codeable expression, that is, it may not have a specific code specifically associated with just that terminology. In this sense, it is ambiguous and could refer to any number of kinds of organ transplants. However, because the expression “end stage renal disease” is also present (e.g., in the same sentence, paragraph or having a proximity within a certain number of words from the token), with this context expression, a trained coder would know that the term transplant in this sentence refers to a kidney transplant and more specifically its status (the status of a kidney transplant that has occurred in the past). This is a codeable expression, specifically, “V42.0” (“KIDNEY TRANSPLANT STATUS”).

Thus, the context algorithm marks vague expressions like “transplant” during a pass through the document. Once preliminary coding has taken place, the algorithm inspects the vague expressions and determines if other terminology associated with particular codes, which is in a proximate context of the vague expression, has been determined that might disambiguate the vague expressions. In the example, the fact that “end stage renal disease” can be encoded (or was encoded), and it is located in the same sentence, allows a system to determine a code with the vague expression. Thus, vague expressions or terminology located in a document, which alone can't be associated with a particular code in the dictionary, can be used to determine a particular code because of its context with respect to other terminology or expressions that may also have particular identifiable codes in the dictionary.

Methodology For Mitigating Over-Coding

In one version, implementing an algorithm to mitigate over coding involved developing a simplified computational model of the English language for the very narrow domain of ICD coding. The first step was to develop a simplified English grammar. The grammar's structure pivots around the terminology of a determined code of the dictionary and includes the context terminology surrounding such a code, which may be limited to a number of terms, e.g., paragraph etc. but for preference as discussed below is limited to the particular sentence. Thus, sentences in this grammar are expressed at the highest level as follows:
Sentence=Pre_string+ICD_Code+Post_string.

In the example, the Pre_string consists of all parts of the sentence that precede the ICD_code. The Post_string consists of all parts of the sentence that succeed the ICD_code. A Pre_string and a Post_string are composed of one or more phrases. Specifically:
Pre_string Phrase1+Phrase2+. . . PhraseN.
Post_string=Phrase1+Phrase2+. . . PhraseN.

Once the grammar was defined, restriction rules were defined that describe relevant logical relationships between expressions found in context (e.g., in the Pre_string, Post_string, or both) and the ICD_code. They are called restriction rules because they restrict the cases in which a code determination algorithm with this methodology assigns a code. For example, a rule may be: “if <expression1> is in the Pre_string, then don't code the ICD_code.” The rules are preferably implemented in the program as abstract expressions with variables (e.g., expression1, expression2) . A file of language tokens can be used to bind the variables at run time. Thus a single abstract rule can be instantiated as hundreds of actual rules once the variables are bound. This modular approach allows the program to easily expand its rule set. The language token files can be edited with any text editor without touching the code.

Example E4 shown below illustrates how this scheme works.
(E4) “She denies any history of abnormal urinalysis such as hematuria, proteinuria, nephrolithiasis, or other genitourinary complaints.”

The simple algorithm would code “hematuria” and “proteinuria.” These expressions are both part of the standard ICD9 dictionary. However, neither coding would be correct. The expressions “hematuria” and “proteinuria” need to be understood in the context of the clause at the beginning of the sentence, “She denies any history of . . .” Any person competent in English would realize that this clause changes the meaning of “hematuria” and “proteinuria.” Within the context of this sentence, these medical terminology tokens no longer represent diagnoses that are applicable to the patient because of the particular phrase of negation “denies.” Instead they are diagnoses that the patient denies ever having. A system implementing such an algorithm has an abstract rule that can be expressed as follows, “If expression1 is in the pre_string and expressioin2 is not in the pre_string then ignore any ICD expressions in the same sentence.” In the language token file, there is a set of two tokens associated with this rule. Token one, “denies” binds to expression1, token two, “although” binds to expression2. The rule as instantiated with these tokens then becomes, “If “denies” is in the pre_string and “although” is not in the pre_string then ignore any ICD expressions in the same sentence.” In other words, if the word “denies” is in the sentence and precedes an ICD expression in the same sentence, and the word “although” does not precede the ICD expression, then do not code the ICD expression.

The system in distinguishing the codes from the restriction context can optionally be identified for human reviewers but in a manner that signals that they should be carefully considered due to the restriction rule analysis or they may be distinguished from other selected codes simply by not identifying such codes at all, i.e., by automatically disregarding them. Thus, the rule prevents a system from inappropriately coding (i.e., over-coding) in this situation. Other phrases of negation in addition to that which has been identified above will be recognized by those skilled in the art or by examination of syntactic or semantic usage.

Moreover, other types of context restrictions may be determined by those skilled in the art for purposes of preventing an automated system from absolutely assigning a determined code despite the presence of the associated medical terminology in the document. For example, other tokens (i.e., expressions#) may include a kinship restriction such as the phrases associated with a relative, parent, sibling, father, mother, etc. where the context of medical related terminology would indicate that the code may be associated with the relative's medical diagnosis rather than the patient who is the subject of the document. Thus, the system may distinguish a determined code from absolute assignment as discussed above because in the context of the sentence it would be describing the medical condition of a mother, father, brother, sister, grandparent, etc.

Exemplar System Description

In the illustrated system developed for ICD code determination (i.e., “ICDScan” or “EMscribe DX”), a convenient software design may include several distinct functions that are useful for setting up a system for processing documents. They are:
Initialization
Initial input preprocessing
Initial identification of diagnoses
Application of restriction rules
Application of context rules
Output

Each of these functions will be discussed in turn below.

Initialization

The program may use several files as follows:

The ICD Dictionary. This is a flat file data structure containing ICD codes and associated expressions (as illustrated in Table 2).

A Language File. The language file contains tokens that bind to restriction rules in the program. Each token is preceded by a number. If the number is not equal to 0, it indicates the rule to which the token should be bound. If the number is equal to 0, it indicates that the token should be bound to the same rule that the nearest preceding token associated with a nonzero number is bound. For example, Table 3 is a fragment from the language file.

TABLE 3

| | |
|---|---|
| 8 | without |
| 0 | for |
| | which |

In the first row of this example, the number 8 that precedes the token “without” indicates that this token is associated with rule number eight. The second token in this example, “for which” is also associated with rule number 8 because the nearest preceding token (“without”) is bound to this rule.

A Context File. The context file is used by the context algorithm (see above) to identify vague expressions for coding. It is a flat file consisting of three fields, shown in Table 4 below:

TABLE 4

| | | |
|---|---|---|
| ZZ00 | 239.9 | 183 |
| ZZ01 | 585 | V42.0 |

The first field (i.e., column 1) is an address, pointed to by a corresponding entry in the ICD Dictionary. The second field (i.e., column 2) is a context code for the vague expression that points to this entry. If the context code is encoded for the same document that contains the vague expression, the vague expression can be coded as something more specific. The third entry (i.e., column 3) is the code of the more specific expression to which the vague expression can be coded. The following is an example that illustrates this structure.

In the ICD dictionary, there is an entry as shown in Table 5.

TABLE 5

| | |
|---|---|
| ZZ01 | transplant |

Like other entries in the dictionary file, it consists of two fields, but with an address and an expression. The prefix “ZZ” in the first field is an indication to the program that this field does not contain a real ICD code. Instead it is a special designation that indicates that the associated expression is vague. The suffix of the first field is an index into the context file. It points to the information in the context file that may allow the vague expression to be coded into something more specific. In this case, the address points to the entry in the context file associated with address 01. Entry 01 in the context file has two codes associated with it (see Table 4). If the code 585 (corresponding to the expression “chronic renal failure,” the context expression) has been encoded by the program, then the word transplant can be replaced by the more specific code “V42.0” (corresponding to the expression “kidney transplant status”).

In the initialization phase, each of the three files described above is read into the program, converted to lowercase, and then stored into individual arrays, allowing the program easy access to the information during processing.

Initial Input Preprocessing

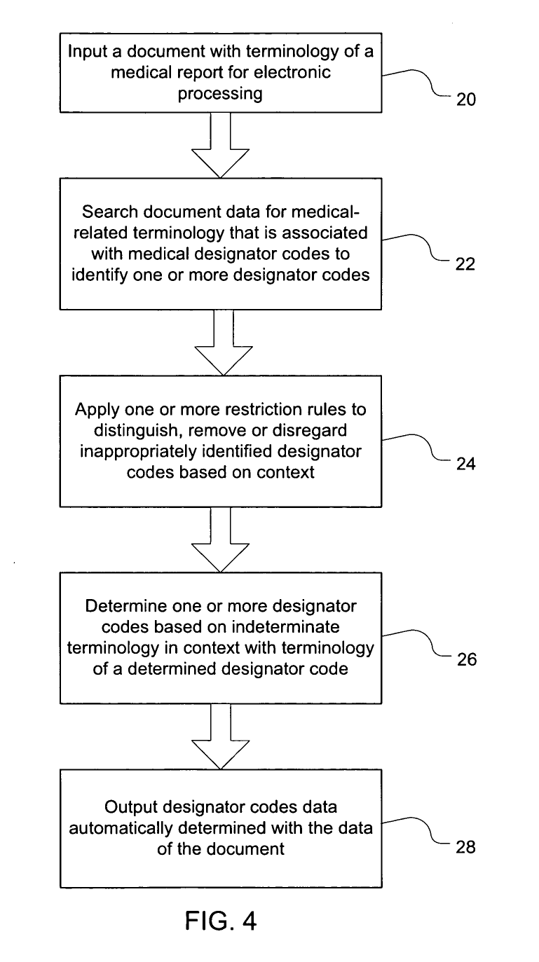

After initialization, the document to be coded is read into the program as data. Generally, documents may originated by scanning paper reports into electronic data by optical scanners, transcribed from voice data or input as text from keyboards, etc. in an input step 20 as illustrated in FIG. 4. For convenience, ICDScan expects the document to be an unformatted electronic txt file. A set of preprocessing functions may be applied to the document. These functions do the following:
Assign special characters to clergy titles so that ICDScan does not confuse them with kinship designations (e.g., father, sister, brother, mother).
Replace all periods (“.”) in the file not designating the end of a sentence with a special character (“*”). Because, the grammar used by ICDScan is used to analyze sentence structure, the program needs to know where the beginning and ending of sentences are in a document. Periods, question marks, and exclamation points are assumed to mark the end of a sentence. However, some periods are used in other contexts (for example, in abbreviations such as Mr. or e.g.). By replacing the periods found in these other contexts with the character “*” the program avoids confusing a period marking an end of a sentence with one indicating something else.
Mark the start and end point of a bullet list. Analysis has shown that bullet lists should be treated as a single sentence for code determination purposes. The punctuation within the bullet list needs to be altered so that the ICDScan program recognizes the bullet list as such.
Put the entire file in lower case. The dictionary, language, and context files when brought into the program are converted to lower case to make searching easier. Making the document all lower case completes this normalization process.

Initial Identification of Diagnoses

In a search step 22, the system sequentially searches the document for each of the expressions in the medical dictionary (e.g., the ICD Dictionary). Expressions are searched sentence by sentence. If a match between an expression in the dictionary and the document is found, the system checks to determine if the expression is part of some other word. For example, the expression “tia” is an entry in the dictionary. However, pattern matches will occur both if the expression exists in a document as a stand alone token as well as if it is imbedded in a word like “initial.” If the dictionary expression is not a part of some other word, the code associated with the expression is compared to the set of codes that the system has already coded for the document. If the code is not a duplicate it is ready to be checked against the restriction rules.

Application of Restriction Rules

In a restriction step 24, restriction rules are applied to remove or distinguish automatically identified codes which should not be assigned to the document. For example, a sentence with an identified ICD expression is then analyzed to determine if any of the thousands of restriction rules apply (for an explanation of how the restriction rules work, see above). If none of the restriction rules apply, then the previously determined code associated with the identified expression is assigned to the set of codes for the document.

Application of Other Context Rules

In a further context analysis step 26, the context of indeterminate terminology is examined for the purposes of considering identifying additional medical codes. In the ICDScan example, once the system has searched for all the expressions in the ICD Code Dictionary, the context algorithm is applied. For each vague expression identified, the context codes are searched for in the list of codes the system has identified for the document. If a context code has been encoded, the system substitutes the more specific expression for the vague expression and assigns the specific expression's ICD code to the set of codes for that document.

Output

Finally, in a medical code output step 28, the system preferably produces a list of codes and associated expressions for each document analyzed. This output can be deposited in a database, sent by email to a client, appended to a word document, completed into an electronic or printed form having fields that would require such information in such fields with or without the original medical document data, etc. depending on the particular solution into or with which ICDScan is integrated.

### Annotated Code Determination Example

The following is an annotated example of an unformatted medical document, which will be in electronic form, to illustrate the methodology suitable for a code determination system for electronically analyzing medical documents to determine medical codes, such as ICD codes. For illustration purposes here, textual references to which an ICD code is applied are indicated in bold and underlined while textual references to which an ICD code is not applied are shown in bold with the reason why they are not applied shown parenthetically and in italics.

Annotated Document Analyzed by ICDScan System
Jay Doe, M.D.
123 Main Street
Anytown, NJ
Re: Harry David
Dear Jay,
Thank you for your very kind referral of Mr. David for evaluation of renal insufficiency. As you know, he is a 68-year-old white male who has a past medical history significant for the following:
1. History of pneumonia about sixteen years ago which they thought initially might have been Legionaires Disease. He had a fever of 104° for four days, lost forty pounds in six weeks, and was subsequently hospitalized. He thinks he may have had some kidney problems and in fact may have seen a kidney doctor at that time but is not sure of any of the details. He did not receive dialysis therapy and it did not appear that he had significant renal insufficiency. He is now noted to have a serum creatinine ranging from 1.4 to 1.6 and a GFR of 41 cc/min in January of this year.
2. History of hypertension maintained on ACE inhibitor.
3. Hyperlipidemia.
4. Gout for the last fifteen years.
5. Episode of hemoptysis back in 1958 with hoarseness which lead him to stop smoking.
6. Questionable enlarged aorta and cardiac murmur for which he saw Dr. Mermelstein. A stress test 2½ years ago was reported as normal.
7. History of hematochezia and had a colonoscopy in August of last year reported as negative.
The patient is now here for evaluation of abnormal renal function. As stated above, in December 2001, his creatinine was 1.6, but then down to 1.4 with a GFR of 41 cc/min. He states that he may have had some renal problems during this hospital for pneumonia but the details are sketchy at this time. There is no history of abnormal urinalysis such as hematuria, proteinuria, nephrolithiasis, or other significant genitourinary complaints. He currently feels well. His medications include Enalapril, Atorvostatin, Allopurinol, Folic acid, and aspirin. He has no known allergies. His past medical history is as stated above. Past surgical history is significant for multiple left eye retinal surgeries (two at Wills Eye Institute and two in Boston) leading to no vision in the left eye. He also had a right cataract. He quit smoking in 1958 but did smoke three packs a day for six years. He denies use of alcohol. He is employed as a credit manager for a textile mill but is going to be starting his own business. His mother died at age 90 of an MI and degenerative diabetes (ICSScan can be implemented to recognize references to others, not the patient and ignore the related text). His father died at 83 of an MI. Review of systems was reviewed in detail on the patient questionnaire with the patient.
Urinalysis shows specific gravity of 1.015 and pH 5. There is trace protein, no rbc and no glucose (ICSScan can be implemented to recognize negation tokens and knows to ignore the related text).
Blood pressure is 130/80 in the left and 132/84 in the right, pulse is 76 and regular, and respirations are 18 and unlabored. In general, this is a well developed 68-year-old white male awake, alert, and oriented times three in no acute distress. The pupils are equally round and reactive to light. Extraocular muscles are intact. The sclera are anicteric. There is no JVD. He has a shell in the left eye noted which reveals the retina to be not visualized. Carotids are 2+ in upstroke. There is no thyromegaly. Heart has a regular rate and rhythm without murmur, rub, or gallop (ICDScan can be implemented to recognize the token “without” and ignore diagnoses in this sentence). The lungs are clear. The abdomen has normal active bowel sounds, is soft and non-tender with no discreet masses although there is a large ventral hernia which is reducible. There is no CVA tenderness. There is trace dependent pedal edema but no rashes, petechia, or purpura. There is no asterixis or focal neurological deficits. Distal pulses are intact in the lower extremities.
My impressions of Mr. David at this time are as follows:
1. Probable CRF in a 68-year-old white male. This may be related to underlying ASCVD, renovascular disease, chronic interstitial nephritis, or glomerular disease with the latter appearing less likely at this time (These are differential diagnoses which ICDScan can be implemented to ignore). I doubt that there is any effect of the ACE inhibitor on his renal function but this will be investigated as well.
2. Other past medical history as stated above.
At this time I have elected to do a baseline renal ultrasound and if there is renal parenchymal asymmetry, proceed with nuclear flow scan or MRangiography of the renal arteries. A repeat 24-hour urine for protein and creatinine clearance as well as protein electrophoresis will be obtained. I have asked him to do home blood pressures and record these. I have asked him to follow-up with you for his medical care. Any old records regarding previous levels of creatinine before the year 2001 would be appreciated. I have asked him to return to the office for further evaluation in four weeks.
Once again, thank you for allowing me to participate in the care of this very pleasant patient.
Sincerely,
Andrew Covet, M.D.

The following table includes ICD9 codes that ICDScan determined with the previous example and which can be electronically generated with the methodology of the system.

TABLE 1

| | |
|---|---|
| 272.4 | HYPERLIPIDEMIA |
| 274.9 | GOUT |
| 366.9 | CATARACT |
| 401.1 | HYPERTENSION |
| 401.9 | HYPERTENSION |
| 486 | PNEUMONIA |
| 569.3 | HEMATOCHEZIA |
| 578.1 | HEMATOCHEZIA |
| 780.6 | FEVER |
| 782.3 | EDEMA |
| 786.3 | HEMOPTYSIS |

In the example, determined codes for Gout as well as Pneumonia are not part of the official ICD9 corpus (both being too general a designation). These are supplemental entries used by ICDScan that can be added, with other such general designators, to the standard ICD dictionary. Thus, although the system is intended for use with particular ICD codes, additional medical diagnosis coding may be implemented with associated medical related terminology so that the system can generate additional analysis of the medical document.

Technical System Architecture Details

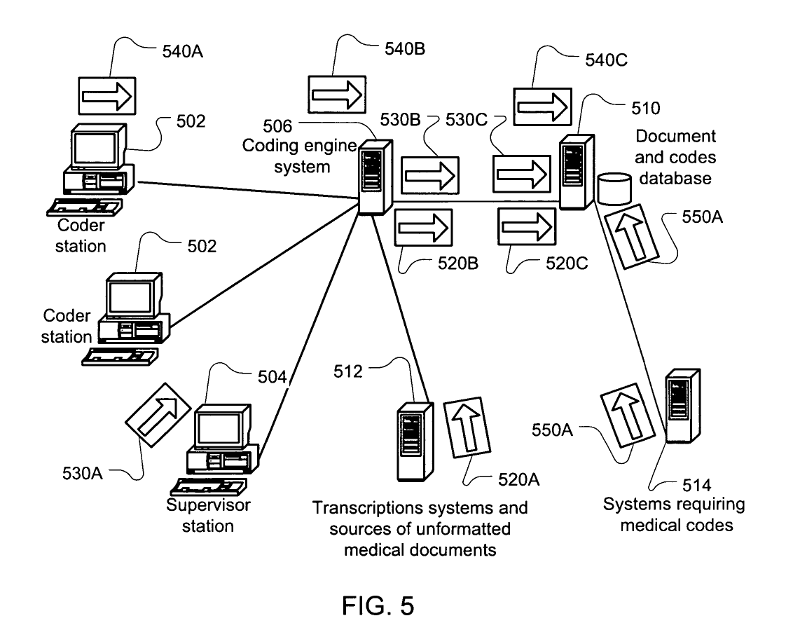

In the following paragraphs, with particular reference to FIGS. 5 through 10, a particularly useful system configuration is illustrated that can include code determination features as previously described but in a networked architecture that permits human overview of automated code determination.

As shown in FIG. 5, an overall network architecture of the system can include four logical data flows that occur in the process of encoding documents utilizing one or more of the methodologies previously described in an ICD encoding example. In the system, coder stations 502 or supervisor stations 504 may be utilized by individuals to oversee or manage encoding of medical documents with the system. Coding engine server 506, which may contain a module for generating ICD codes from unformatted medical records, may be accessed by coder stations 502 over a network or open network, such as an internet or the Internet, preferably using encrypted communications. The coding engine server 506 transmits user interfaces, such as with a web server application, for the coder stations 502 to utilize the module of the coding engine server 506.

A transcription system 512, such as the transcription systems of a hospital or other medical services provider, serves as a source for unformatted electronic medical documents to be coded with the coding engine server 506. Thus, the transcription system 512 also communicates with the coding engine server 506 which may also be communicated over open networks in a secure manner as previously described.

Results of the document coding may be communicated by the coding engine server 506 to a code result database server 510, such as an SQL database server. This code result database server 510 may also be accessed by or communicate with billing systems 514 or other systems, such as hospital or medical services provider systems, which require the medical designator codes that have been determined by the coding engine server 506 and stored in the code result database server 510.

Examples of appropriate data interfaces that may be utilized to mediate communication between these functional components or systems as described above are:
1. HL7 over TCP/IP. This interface mediates communication between various components of the encoding system and hospital IT systems (e.g., between the transcription system 512 and the coding engine server 506).
2. JDBC. This interface mediates communication between the coding engine server 506 and the code result database server 510.
3. HTTP. This interface mediates communication between the supervisor station 504 and human coder stations 502 and the webserver of the coding engine server 506 that holds the access applications.

Data Flow

In a system as just illustrated, there are generally four process flows that describe how data flows for the purpose of determining medical designator codes (e.g., IDC codes) or the like from unformatted medical documents and utilizing such determined codes. They are:
1. The Coding Engine Flow. From a hospital transcription system 512, information is pushed (step 520A) to the coding engine server 506. The coding engine server 506 applies codes to the documents (step 520B) and then sends (step 520C) the coded documents to a code result database server 510.
2. The Supervisor Station Flow. Supervisors from a supervisor station 504 (e.g., a web accessible computer) access (step 530A) a web-based application found in the coding engine server 506. This application provides access (step 530B) into the code result database sever 510. Supervisors can review documents and assign them to individual coders. They can also review coders work as well as perform coding themselves. The output of the supervisors work (assignments, coded documents, reviewed documents) is then stored (step 530C) in the code result database server 510.
3. Human Coder Flow. Human coders from a coder station 502 (e.g., a web accessible computer) access (step 540A) a web-based application found in the coding engine server 506. This application provides access into the code result database 510. Coders can review documents assigned to them by supervisors or review unassigned documents. They can apply codes to documents missed by the coding engine, delete codes incorrectly assigned by the coding engine, and approve coded documents (step 540B). The output of the human coders work is then stored (step 540C) in the code result database server 510.
4. Data Output Flow. The code result database sever 510, periodically pushes (step 550A) information to billing systems 514 and other code requiring systems that utilize the coded information (step 550B). Optionally, these user systems can pull the information directly from the code result database server 510).

Coding Engine Application Interface

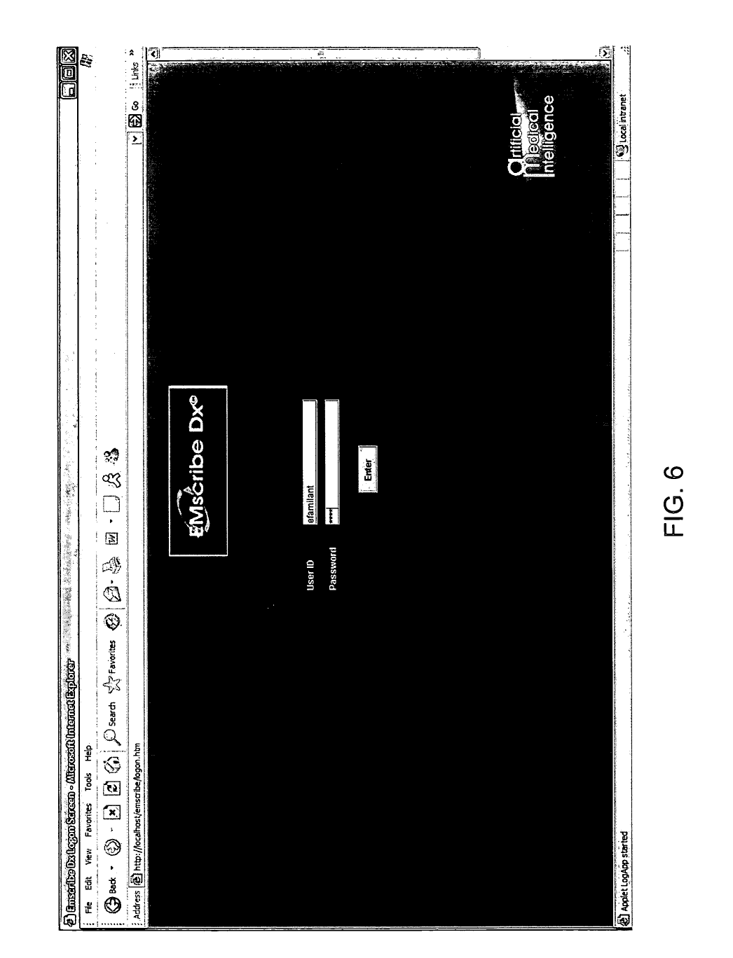

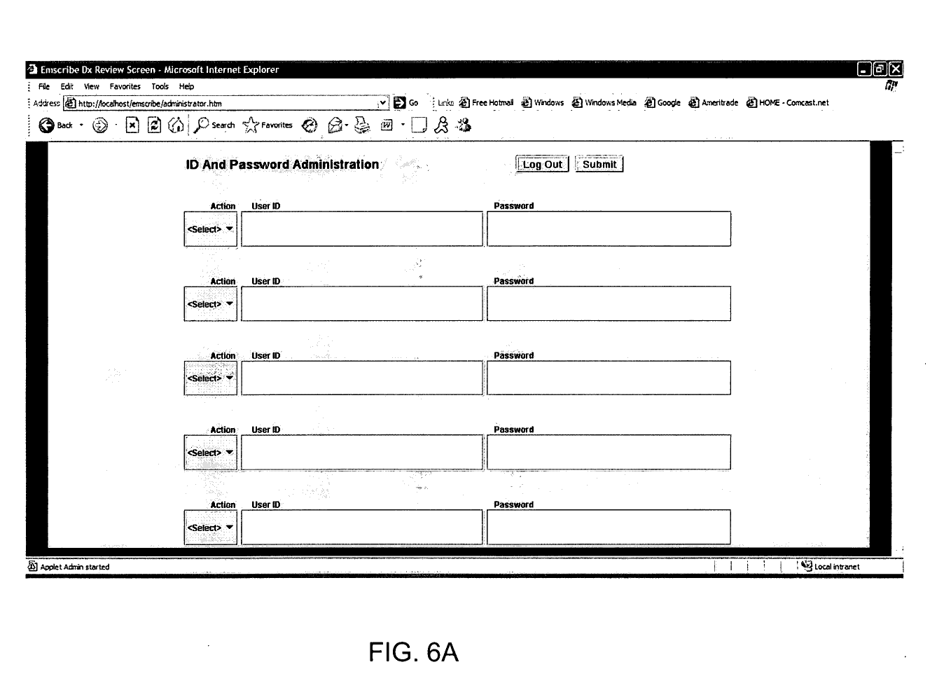

An example user interface for users to work with coded documents and the coding engine is illustrated in FIGS. 6 through 12. As previously noted, there preferably are two types of users of the system: coders and supervisors. Their roles are generally described in the following paragraphs.

A user of the coder station reviews the codes of medical documents automatically determined by the coding engine. The user may delete and add codes to these documents based on expert human judgment. Once a document is reviewed and edited (if needed) it is approved and uploaded to the database server 510.

A user of the supervisor station assigns documents to be reviewed by users of the coder stations, reviews the work of other users, providing final approval, and can do the functions of a user of the coder station.

Both users of the coder station and supervisor station have to log on to the system, preferably with a username (i.e., user ID) and password. This username and password may define the nature of the work each is capable of with the system as described above. In other words, the username and password define whether a particular computer can act as a coder station or supervisor station. A sample logon screen is illustrated in FIG. 6. The database server may store the usernames and passwords along with the user's role so that the appropriate interface is displayed based on this role upon log in. An illustrative interface for adding, changing or deleting usernames and passwords is depicted in FIG. 6A, which may be accessed by a system administrator or supervisor.

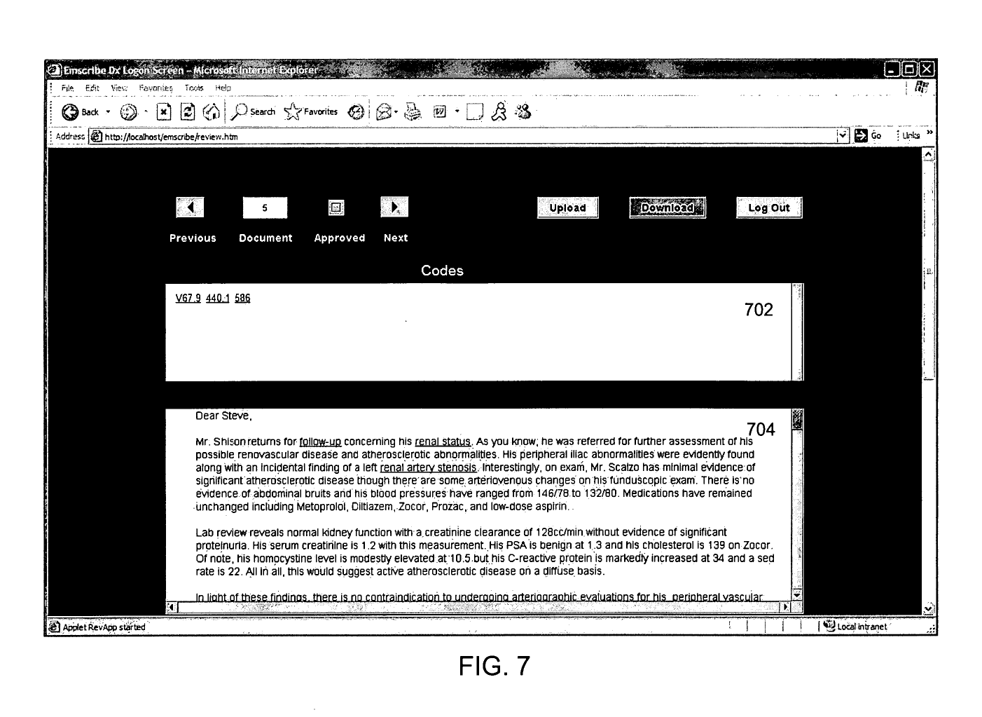

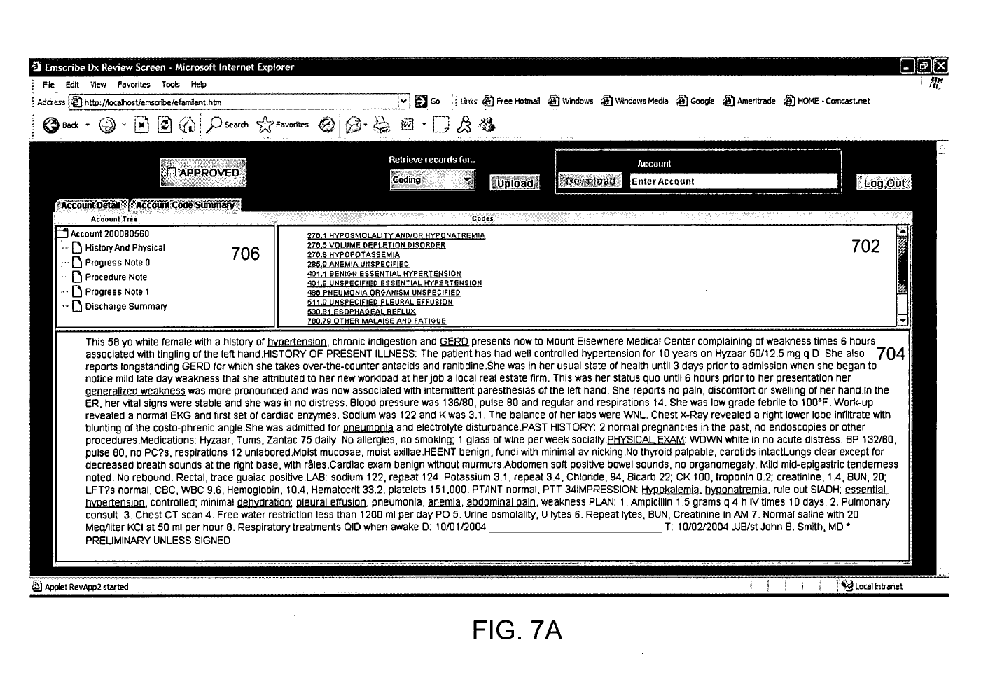

FIG. 7 illustrates a basic document review screen of the coder station 502 from which the user can work. The screen illustrates a code pane 702 showing the medical identifier codes associated with a document applied to the coding engine. For convenience, a document pane 704 also displays the document from which the codes were determined. The system is also configured, as illustrated in the document pane 704, to generate highlight in the text of the document, for example, by underlining, to emphasize terms that have been utilized by the coding engine to identify a particular code.

For example, the code pane 702 contains a concise summary of all codes, (e.g., ICD codes), applied to the document (either by the coding engine or a human user of the coder station or supervisor station). Each individual code is a conveniently created as a hyperlink. Clicking on the code in the code pane 702 will cause the token or medical related terminology of the medical document which the code corresponds to be selected in the document pane 704. In response, the system will scroll the document in the document pane 704 to the related medical terminology.

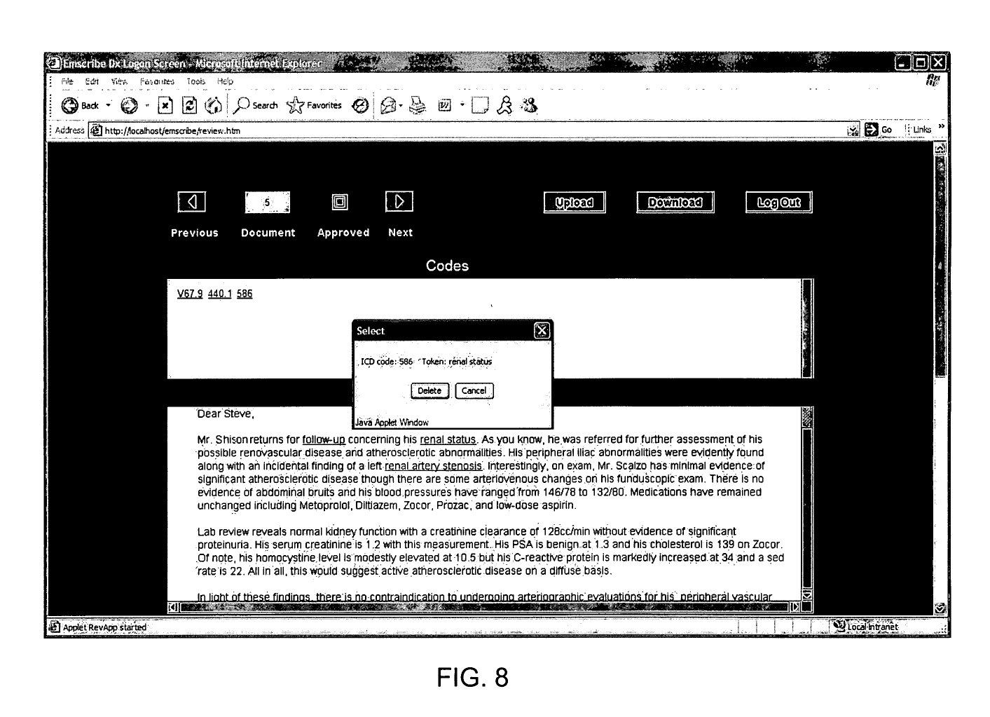

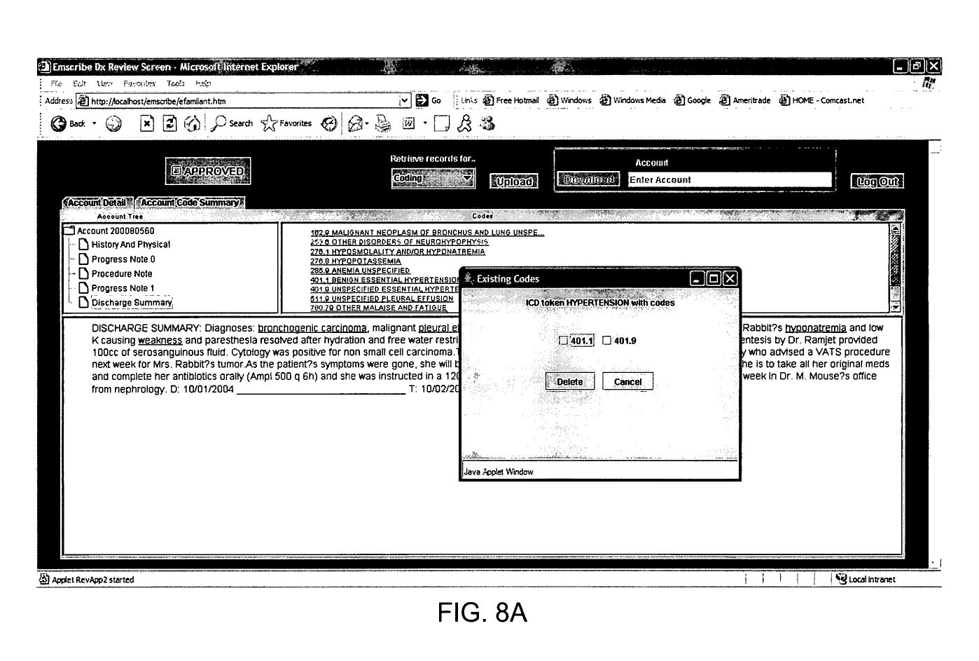

The user of the coding station can also scroll through the actual document. Clicking on an encoded token or the medical related terminology of a document associated with a determined code (e.g., the text that may be underlined and in a different color for purposes of emphasis) in the document pane 704 will cause a dialogue box to pop up, as illustrated in FIG. 8. The dialogue box displays the determined code and provides the user with the opportunity to delete the code corresponding to the token from the document. Multiple codes may also be deleted as illustrated in the interface of FIG. 8A. In the dialog box, a user is presented with the option to delete one or more selected codes by clicking on check boxes of the interface.

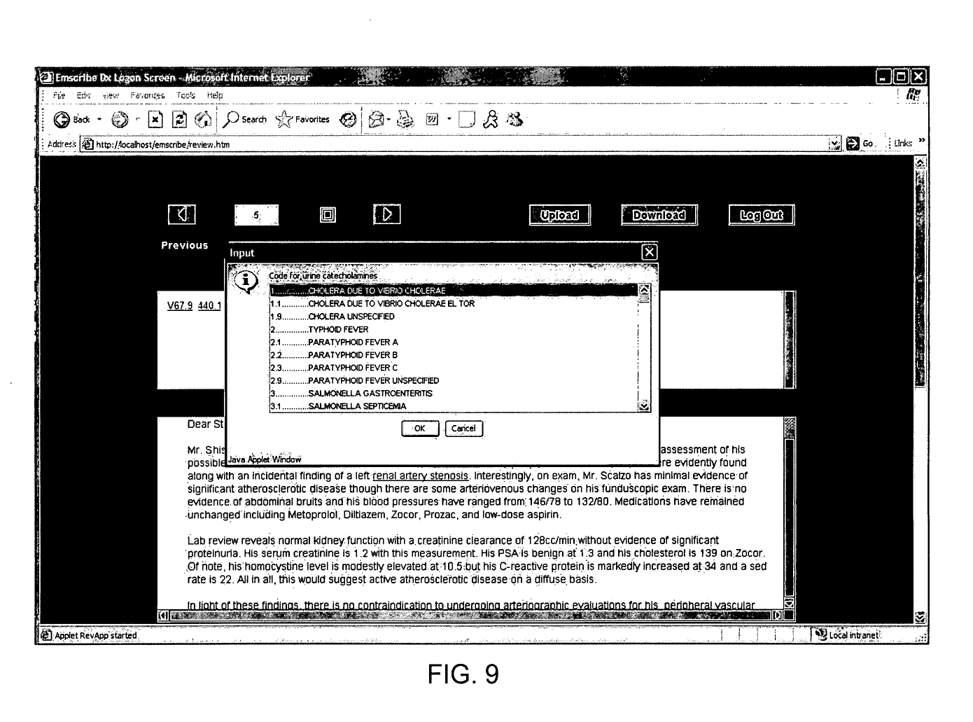

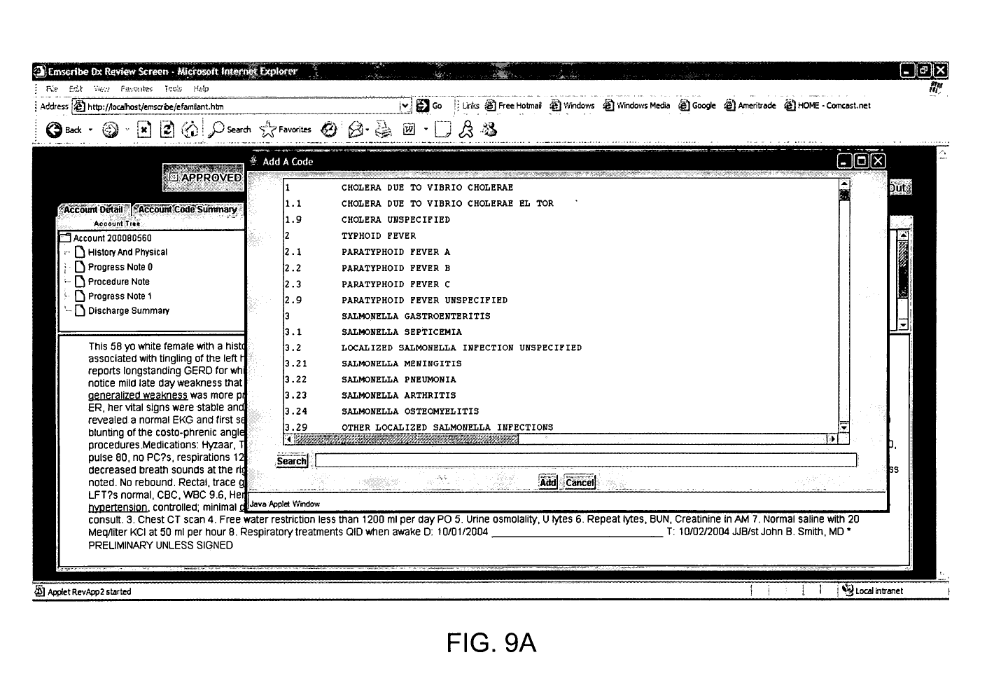

The interface of the coder station, as illustrated in FIGS. 9 or 9A, also permits its users to add codes to a document. To do this, the user may select with a pointing device, for example, text or medical related terminology from the document in the document pane 704 that the user wants to encode. The coder then right clicks on the selection. On doing this, a dialogue box pops up, shown in FIGS. 9 or 9A, with a list of all the medical designator codes (e.g., ICD codes). The user can scroll through the list of codes until the desired code is found. Then the user can select the code and it will be applied to the document upon selecting the “ok” icon. On selection, the corresponding code is added to the code pane 702 and the token (i.e., related medical terminology of the document) is emphasized (e.g., underlined, bold, colored, etc.) in the document pane 704. AS illustrated in FIG. 9A, a user can enter search text including medical terminology or codes to directly search through the code dictionary by clicking the “search” icon for purposes of finding codes in the dictionary and then manually adding found medical codes to the document upon selecting an “add” icon.

An alternative embodiment of a user interface of the coder station, comparable to the interface of FIG. 7 is illustrated in FIG. 7A. The document pane 704 and code pane 702 of FIG. 7A also provide similar functionality as described with regard to FIG. 7.

The interface of FIG. 7A also includes a documents management pane 706 for depicting a collection of documents with a brief text description that are each associated with a particular account, for example, several medical documents for a particular patient, several documents for a particular physician, etc. Each document is an active link, the selection or clicking of which by a pointing device etc., will cause the corresponding document to be displayed in the document pane 704, which in turn will display the selected medical codes corresponding with the selected document in the code pane 702.

In the code pane 702 of FIG. 7A, selected medical codes as well as the particularly associated medical terminology from the medical code dictionary may also be displayed. Optionally, the medical codes displayed in the code pane 702 may be displayed for some or all associated documents depicted in the documents management pane 706, and not just the document displayed in the document pane 704. For purposes of making a distinction between the medical codes when displayed medical codes of different associated documents are displayed in the codes pane 702, the medical codes 704 may be emphasized to distinguish their association to particular documents of the documents management pane 702.

For example, the medical codes of the code pane 702 are emphasized, such as by color coding, to indicate whether or not the displayed medical code of the code pane 702 is related to the document of the document pane 704. Medical codes appearing in multiple documents can share a common display characteristic, such as a green color emphasis. Medical codes of the code pane 702 that only are associated with the document of the document pane 704 may have a particular emphasis such as a blue color. Similarly, a particular emphasis to a medical code of the code pane 702 may be associated with a particular or special document of the documents management pane 706, such as a discharge summary document. Such an example may be red color emphasis, that may indicate that the code is only associated with the discharge summary document, rather than other documents, such as progress and procedure note documents or history and physical report documents. Additionally, a particular display emphasis to a code may indicate whether one or more medical codes have previously been designated as primary codes or key codes as discussed in more detail herein. For example, a key code may be displayed in a blinking, bolded or italicized text or otherwise in a unique color etc.

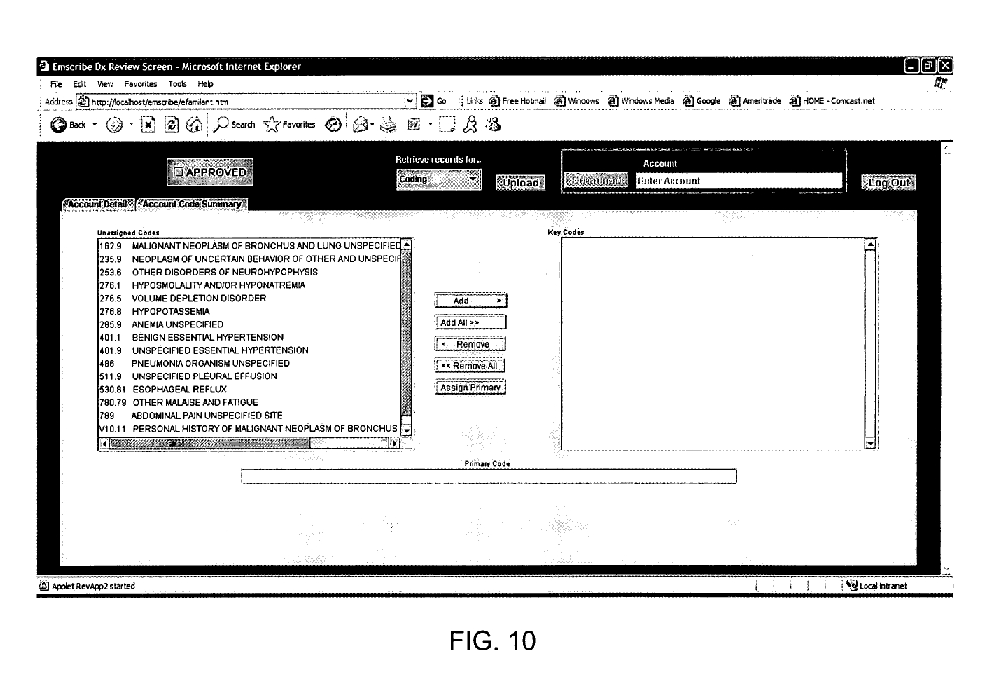

An alternative display interface for showing all of the medical codes selected and assigned for all documents of a common account or multiple accounts is illustrated in FIG. 10. From this interface a user can select particular medical codes for purposes of making primary code and/or key code designations. For example, certain of the medical codes may be reimbursable. Thus, a user may designate key codes for which an entity may desire and apply for reimbursement or payment. The key codes may then be applied to an electronic or hard copy form or transmitted to an insurance company for reimbursement or payment. Additionally, a primary code may be designated to indicate a main medical reason that a patient had entered a medical facility such as a hospital. The primary code designation is then associated with the selected medical code(s).

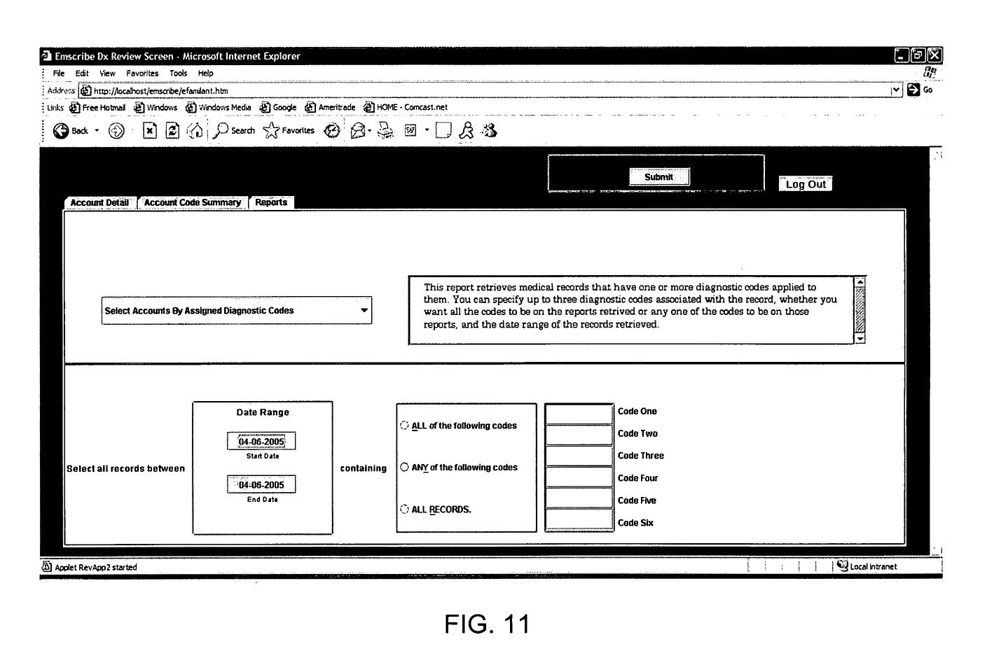

The interface may also be implemented with reporting features for examining multiple medical documents according to or based on the medical codes that have been selected and assigned to the documents. An interface for specifying search criteria to identify documents by such a search within a particular account or in multiple accounts is illustrated in FIG. 11. The example interface permits entry of date ranges associated with the documents for purposes of a search and/or selecting particular medical codes that can be present in the documents. As illustrated in the interface, if a search uses medical codes as part of the search criteria, one or more such codes may be identified and can be control the search to identify documents based on whether all or some are selected and assigned to the searched documents.

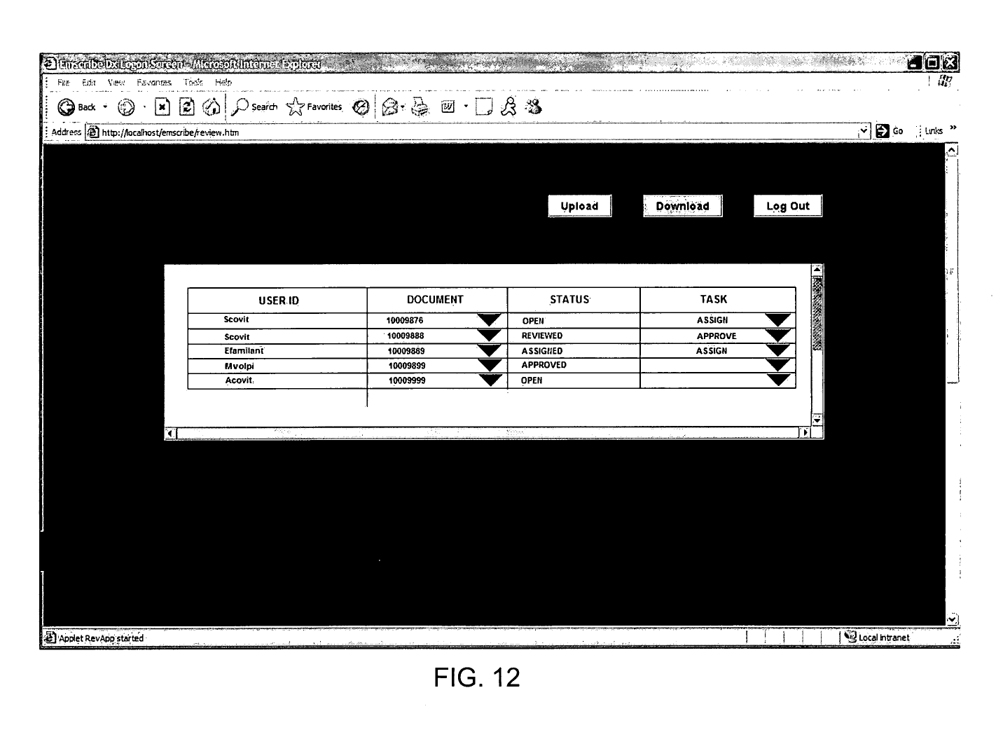

An interface providing functionality in addition to some or all of that which has just been described but for an authorized user of the supervisor station 504 is illustrated in FIG. 12. The display shows usernames of users of coder stations in the first column of the table. Individual documents with medical related terminology of the database server 510 can be selected in the second column, using a pull-down menu. The status of the document is shown in column three. In column four, the task associated with the document can be selected by the supervisor using a pull down menu. The supervisor can choose to assign the document to an associated user of the coder station, review the document, or provide final approval of the document.

Numerous modifications and alternative embodiments of the invention will be apparent to those skilled in the art in view of the foregoing description. Such as the unformatted data can be captured digitally (e.g. from a paperless charting system), from scanning of typed notes and/or printed notes, as well as from speech using a speech to text conversion and capture system. The system can be ideally suited for use on batch transactions but can also be used in a real time environment. Various medical code determination dictionaries may be used such as ICD, CPT etc. Similarly, although a centralized networked version of the system has been described for use by multiple medical service providers, the system may be configured for individual use for the needs of a single medical service provider such as a medical office, hospital or medical insurance company. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims, is reserved.

1. n automated system for determining medical codes from unformatted medical document data comprising:
a data structure including medical codes data associated with medical terminology data;
processor searching control instructions configured to search document data input to the system to automatically identify medical terminology data of the data structure located in the document data and to automatically select one or more medical codes of the data structure that are associated with the identified medical terminology data; and
processor output control instructions configured to generate output comprising a selected medical code associated with the medical document data;
wherein the processor search control instructions are further configured to automatically examine a context of the identified medical terminology data in the document data and the selection of a medical code of the data structure is also based on the result of the examination of the context.

2. The system of claim 1 wherein the context comprises a sentence of the medical document data.

3. The system of claim 2 wherein the examination of context comprises identifying further medical terminology data in the same context as the identified medical terminology data, the identified further medical terminology data not associated with a unique medical code in the data structure, and selecting a medical code based on the identified further medical terminology data and a selected medical code that is associated with the identified medical terminology data.

4. The system of claim 1 wherein the processor search control instructions are further configured to distinguish an associated medical code of identified medical terminology data of the document data as a result of the examination of the context.

5. The system of claim 4 wherein the processor search control instructions are further configured with a restriction rule including a kinship phrase, wherein the system distinguishes the medical code as a result of an identified kinship phrase in the context of the document data.

6. The system of claim 4 wherein the processor search control instructions are further configured with a restriction rule including a phrase of negation, wherein the system distinguishes the medical code as a result of an identified negation phrase in the context of the document data.

7. The system of claim 4 wherein the system disregards an associated medical code of identified medical terminology data of the document data as a result of the examination of the context.

8. The system of claim 4 wherein the medical code data of the data structure comprises ICD codes.

9. The system of claim 2 wherein the medical terminology data of the data structure comprises abbreviated medical terminology.

10. The system of claim 2 wherein the medical terminology data of the data structure comprises slang medical terminology.

11. The system of claim 2 wherein the medical terminology data of the data structure comprises misspelled medical terminology.

12. The system of claim 2 wherein the medical terminology data of the data structure comprises lay medical terminology.

13. The system of claim 8 wherein the processor output control instructions are further configured to insert a selected medical code into a form.

14. A method for an automated system to determine medical codes from unformatted electronic medical report document data containing medical terminology comprising:
searching an electronic document to automatically locate occurrences of medical terminology data in the electronic document, the medical terminology data being associated with medical designator code data in a dictionary data structure;
automatically selecting a medical code of the medical code data from an automatically located occurrence of medical terminology from the electronic document; and
generating output comprising the automatically selected medical code associated with the medical document data.

15. The method of claim 14 further comprising automatically examining a context of an occurrence of medical terminology data in the medical report document data and automatically selecting a medical code based on the examination of the context.

16. The method of claim 15 wherein an automatically selected medical code is determined based on first medical terminology of the document data not directly associated with a particular medical code and a selected medical code associated with second medical terminology located in the context of the first medical terminology in the document data.

17. The method of claim 15 further comprising automatically distinguishing a selection of a medical code associated with located medical terminology of the document data based on the result of the examination of the context.

18. The method of claim 17 wherein the distinguishing comprises automatically identifying a phrase of negation in the context of the located medical terminology.

19. The method of claim 17 wherein the distinguishing comprises automatically identifying a phrase of kinship in the context of the located medical terminology.

20. The method of claim 19 wherein the distinguishing further comprises automatically rejecting a medical code.

21. The method of claim 17 wherein the context comprises a sentence of terminology data of the medical document data.

22. The method of claim 16 wherein the medical terminology data of the dictionary data structure comprises abbreviated medical terminology.

23. The system of claim 16 wherein the medical terminology data of the data structure comprises slang medical terminology.

24. The system of claim 17 wherein the medical terminology data of the data structure comprises misspelled medical terminology.

25. The system of claim 17 wherein the medical terminology data of the data structure comprises lay medical terminology.

26. The method of claim 21 further comprising automatically inserting a selected medical code into a form.

27. An automated system for determining ICD medical codes or the like from unformatted electronic medical report document data comprising:
an electronic table data structure including medical codes data associated with medical terminology data;
a processor configured for searching through medical report document data input to the system to automatically identify medical terminology data in the medical report document data, and for automatically selecting a medical code of the electronic table data structure that is associated with the identified medical terminology; and
wherein the processor is further configured for generating output comprising an automatically selected medical code associated with the medical document data.

28. The system of claim 27 wherein the processor is further configured for automatically examining a context of the identified medical terminology in the medical report document data and automatically accepting or rejecting the selected medical code based on the result of the examination of the context.

29. The system of claim 27 wherein the processor is further configured for automatically examining a context of identified medical terminology in the medical report document data and for automatically selecting a medical code based on the result of the examination of the context.

30. The system of claim 29 further comprising a document input device for accepting as input a medical document.

31. The system of claim 29 wherein the document input device comprises an electronic transcription system.

32. A system for automatic assignment of medical codes to unformatted data, the system comprising:
document reading unit for reading a document;
assessment unit for scanning the document for diagnoses associated with ICD codes; and, output unit;
wherein when a diagnosis is identified, the system looks at the language context in which the diagnosis appears, using rules derived from syntactic and semantic usage, and decides whether to apply an identified ICD code or not.

33. The system of claim 32 further comprising an electronic restriction rule including a phrase of negation.

34. The system of claim 32 further comprising an electronic restriction rule comprising a phrase of kinship.
